(19) United States
(12) Patent Application Publication
(10) Pub. No.: US 2014/0278668 A1
(43) Pub. Date: Sep. 18, 2014

(54) Recommendation of Geographic and Temporal Meeting Locations

(71) Applicant: QUICK TECHNOLOGIES, LLC, Boston, MA (US)

(72) Inventors: Jeremy J. Paradise, Boston, MA (US); Ilan Dee, Waltham, MA (US); Doug A. Brenhouse, Boston, MA (US)

(73) Assignee: QUICK TECHNOLOGIES, LLC, Boston, MA (US)

(21) Appl. No.: 13/795,018

(22) Filed: Mar. 12, 2013

(51) Int. Cl. G06Q 10/10

(52) U.S. Cl. CPC G06Q 10/1095
USPC 705/7.19

(57) ABSTRACT

Recommending one or more geographic locations and one or more temporal locations for a first individual and a second individual to meet includes receiving first data from the first individual and second data from the second individual. The received first data specifies at least the first individual's preferred geographical attributes and preferred temporal attributes. The received second data specifies at least the second individual's preferred geographical attributes and preferred temporal attributes. The received first data, the received second data, and a recommendation engine, one or more recommended geographic locations and one or more recommended temporal locations that satisfy some respective preferred geographical attributes and the respective preferred temporal attributes is determined. The one or more recommended geographical locations and the one or more recommended temporal locations are transmitted to at least one of the first individual and the second individual. Related apparatus, systems, techniques, and articles are also described.

### TECHNICAL FIELD

The subject matter described herein relates to the recommendation of geographic and temporal meeting locations to aid in scheduling a meeting between two or more individuals.

### BACKGROUND

An online marketplace is a type of ecommerce site that enables multiple third parties to sell and/or buy product and inventory information. The marketplace operator can process transactions between users. Example online marketplaces include Quickable™ Marketplace, Facebook®, Amazon.com®, Ebay®, Craigslist™, and Google Shopping®. Merchants or individuals wishing to sell products can use online marketplaces as channels for increased sales. Additionally, an online marketplace can receive a commission for goods sold through their marketplace.

Typically, a merchant (i.e. a seller) will post an offer to sell a product to an online marketplace. The offer for sale will specify a description, price, and can specify additional details (e.g. title, category, condition, duration of offer, if the price is negotiable, etc.). The offer for sale can be viewable by buyers. A buyer, browsing or searching the online marketplace, can buy or make an offer to buy the product. The seller and buyer can then complete the transaction by exchanging product for payment. The online marketplace can serve as a trusted intermediary in the transaction by providing for and enabling the exchange of product for payment. Alternatively, the transaction can be completed between the seller and buyer independent from the online marketplace e.g. in person or via a postal service.

When a seller and buyer agree to complete a transaction in person, determining a suitable meeting time and location can be difficult. The individuals may not know very much about each other (e.g., what are their work schedules? Do they work? Do they have a car or must they take public transportation?). The lack of information makes it difficult to know where to begin suggesting a location. To complicate the problem, communication between individuals can be limited to email or instant messaging.

### SUMMARY

In one aspect, recommending one or more geographic locations and one or more temporal locations for a first individual and a second individual to meet includes receiving, at a server, first data from the first individual and second data from the second individual. The received first data specifies at least the first individual's preferred geographical attributes and preferred temporal attributes. The received second data specifies at least the second individual's preferred geographical attributes and preferred temporal attributes. Using the server, the received first data, the received second data, and a recommendation engine, one or more recommended geographic locations and one or more recommended temporal locations that satisfy at least some of the respective preferred geographical attributes and the respective preferred temporal attributes is determined. Using the server, the one or more recommended geographical locations and the one or more recommended temporal locations are transmitted to at least one of the first individual and the second individual.

One or more of the following features can be included. For example, geographic attributes can include a boundary of a geographic region. The geographic region can include a plurality of geographic locations and all geographic locations within the geographic region can be preferred locations to meet for an associated individual. The boundary of the geographic region can be specified by a current position of the associated individual and a maximum distance the associated individual is willing to travel. The current position can be automatically determined. Geographic attributes can include a safety measure, a convenience measure, and business type. Temporal attributes can include a predefined schedule of availability of an associated individual. Temporal attributes can include a range of time specifying an availability of an associated individual. Temporal attributes can include a reoccurring range of time specifying an availability of an associated individual.

The first individual and the second individual can be meeting to finalize a previously agreed upon transaction. The server can further use details of the transaction to determine the one or more recommended geographical locations. The details of the transaction can include at least one detail selected from a group consisting of: monetary value to be exchanged, type, size, and number of products to be exchanged. The server can further use secondary attributes associated with an individual to determine the one or more recommended geographical locations and the one or more temporal locations. The secondary attributes can include a relationship to another individual and historical transaction data associated with the individual.

Preferred attributes can include a plurality of attributes, each attribute associated with a measure of importance. The recommended one or more geographical locations can be suboptimal and the recommended one or more temporal locations can be suboptimal. The recommended one or more geographical locations can be presented to at least one of the first individual and the second individual for confirmation. The recommended one or more temporal locations can be determined independently from the recommended one or more geographical locations. The first individual can be prompted to choose a preferred geographic location from the one or more recommended geographic locations and a preferred temporal location from the one or more recommended temporal locations

The recommendation engine can be an inference engine.

Computer program products are also described that comprise non-transitory computer readable media storing instructions, which when executed by at least one data processors of one or more computing systems, causes at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems.

The subject matter described herein provides many advantages. Once buyers and sellers confirm a transaction on an online marketplace, they can quickly and easily establish a meeting for finalizing the transaction. A user can choose between a plurality of recommended geographic locations and times. Each recommended location and time has a higher likelihood to be acceptable for all individuals involved with the transaction. Further, the current subject matter considers each individual's preferences for meeting locations and times. The user experience for an individual buying and/or selling a product on an online market place is thereby enhanced.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating a method for recommending a geographic and a temporal location for a plurality of individuals to meet to finalize a previously agreed upon business transaction;

FIG. 2 is an example user interface for selecting preferred geographic and temporal attributes; and

FIG. 3 is an example user interface that can prompt to a user to display the determined recommended locations.

### DETAILED DESCRIPTION

FIG. 1 is a process flow diagram 100 illustrating a method for recommending a geographic and a temporal location for a plurality of individuals to meet. The meeting can be to finalize a previously agreed upon business transaction. The individuals can have arranged the business transaction using an online marketplace or another medium for arranging a business transaction. The individuals can have used a computer, smart phone, or other device to arrange the business transaction. The geographic locations can be specific locations that are convenient to all individuals involved in the transaction, for example, a coffee shop, individual's home, or other place of business. Similarly, the temporal locations can be specific times that are convenient to all individuals involved in the transaction, such as a point in time. The individuals can be buying or selling a specific product (i.e., good or service) and the exchange of one or more of the product and/or the payment can comprise finalizing the transaction.

At 110, a server receives preferred geographic attributes and preferred temporal attributes from each of the individuals involved in the transaction. The geographical attributes are attributes or criterion associated with preferred locations. For example, a specific individual may prefer to meet at locations only within 5 miles of their house or only within a specific geographic region such as a zip code, city, county, state, etc. Additionally, the individual may prefer to meet at coffee shops, which may be safe venues to meet strangers and conducive to conducting business transactions. Alternatively, the individual may prefer to meet at their private home (i.e., have the other individuals come to their home for convenience). Other preferred attributes can include the type of preferred location such as a public location (e.g., a police station, a public garden or park, post office, etc.), private location (e.g., private home or other property), specific type of business (e.g., coffee shops, restaurants, etc.). A measure of safety can be an attribute. For example, rather than specifying coffee shops and police stations, an attribute can specify a level of safety (e.g., only “very safe” locations are preferred) Similarly, a measure of convenience can be an attribute. Other types of attributes are possible. There can be multiple preferred geographic attributes (e.g., coffee shops, restaurants, and within 5 miles of the individual's current location).

Temporal attributes are attributes or criterion associated with preferred meeting times. Temporal attributes can include a predefined schedule of availability such as a calendar. Additionally, the temporal attributes can include a range of time, and the range of time can be reoccurring (e.g., example temporal attributes could convey that an individual is available Monday through Thursday between six PM and eight PM).

At 120, the server determines one or more recommended geographic locations and one or more recommended temporal locations. The server uses at least each of the received preferred geographic attributes and the received preferred temporal attributes and a recommendation engine to make the determination. A recommendation engine is an information filtering system that seeks to predict (i.e. recommend) the “preference” that an individual would give to a geographic and temporal location they had not yet considered, using a model built from the characteristics of geographic and temporal locations. The recommendation engine can utilize a series of discrete attributes of a geographic and temporal location in order to recommend additional locations with similar attributes. The model used by the recommendation engine can be based on the previously discussed geographic and temporal attributes. For example, the recommendation engine, knowing characteristics about possible locations within a region, could recommend a location because it is a police station and police stations are “very safe.” As discussed above, an individual can preselect, according to their preferences and needs, desired attributes of recommended geographic and temporal locations. Additional attributes can be inferred and need not be explicitly entered by an individual.

The recommendation engine can be an inference engine. An inference engine is a computer program that tries to derive recommendations from a knowledge base (e.g., a set of known possible locations and explicit or implicit attributes associated with each location). It attempts to reason about information in the knowledge base for the ultimate purpose of formulating new conclusions. In this case, the new conclusion is one or more recommended meeting locations.

The determination of the recommended geographic locations can be independent of the determination of the recommended temporal locations. This has the advantage that individuals can be presented with a plurality of recommended temporal locations and a plurality of recommended geographic locations and be able to choose from each category. Alternatively, the determination of the recommended geographic locations can depend on the recommended temporal locations. For example, a geographic location such as a public park may be a more desirable venue for meeting to finalize the transaction during the day than at night and a coffee shop may be recommended only when it is open for business.

The server can use contextual information such as details relating to the transaction or secondary information associated with one or more individuals to recommend geographic locations. The server can also use details of the transaction when determining the recommended geographic and temporal locations. The details can include the monetary value of the product being exchanged; the form and amount of payment being exchanged; and additional characteristics of the product being exchanged. For example, if the monetary value of the product is high, such as jewelry or expensive electronics, then the server can recommend a safer geographic location (e.g., a police station) and a safer temporal location (e.g., during the day). If the transaction involves a large amount of cash, than the server can recommend a bank at a time when the bank is open for business. If the product requires activation, registration, testing, authentication, etc., the server can recommend a suitable location to enable that action. For example, if the product is a cellular phone that only works with a specific cellular service carrier, (e.g., AT&T) the server can recommend that carrier's store (e.g., an AT&T store) to enable activation of the phone.

The server can also use secondary attributes associated with an individual involved in the transaction. The secondary attributes can include a relationship to another individual involved in the transaction. For example, if the individuals are connected directly or indirectly on a social networking site (e.g., “friends”) then the recommended geographic location could include one of the individual's home or other locations. Another secondary attribute can include historical transaction data associated with an individual. For example, if an individual has completed hundreds of transactions with other unrelated individuals and received positive reviews on an online marketplace (i.e., has a good “track record”), the server can recommend a “less safe” geographic and temporal location.

It could be impossible to determine an optimal recommended geographic location and temporal location. The attributes of multiple individual's involved in the transaction may be contrary to each other. For example, each individual involved in the transaction may prefer to finalize the transaction at his or her respective private home. Therefore, the recommended geographic and temporal locations may not satisfy all preferred attributes by any or all of the individuals involved in the transaction. The server can also use a priority or measure of importance for each of the geographic and temporal attributes and an individual can prioritize some or all of the attributes.

At 130, the server transmits the one or more determined geographic recommendations and the one or more temporal recommendations. The server transmits the recommendations to one or more of the individuals involved in the transaction. A computer, smart phone, or other device can present the transmitted recommendations to one of the individuals involved in the transaction for confirmation.

FIG. 2 is an example user interface 200 for selecting preferred geographic and temporal attributes. At 210, a user (i.e., individual) can select a measure of safety that the user is willing to tolerate. At 220, the user can enter a maximum distance the user is willing to travel to finalize a transaction, and at 230 the user can select one or more preferred location types such as coffee shops and restaurants. At 240, the user can choose to upload a calendar. In this manner, a user can easily select their preferred attributes for both geographic and temporal locations. The attributes do not need to be set by an individual involved in the transaction but can have default settings.

The current subject matter can be used to aid in finalizing a transaction. For example, an individual can either buy or sell a product on an online market place. Once both a seller and a buyer have agreed to a transaction, the buyer and seller confirm the transaction. Then the individual (the buyer, the seller, or both) can be prompted, using the current subject matter, with recommended meeting locations to finalize the transaction.

FIG. 3 is an example user interface 300 that can prompt to a user (i.e., an individual) to display the determined recommended locations. The example interface 300 displays three recommended locations (both geographic and temporal locations) for the user to choose. At 310, the first recommendation is provided. In this example, the first recommendation is “Coffee House on Broad Street at 2:30 pm Tuesday.” At 320, the second recommendation is provided. In this example, another coffee shop, “Pete's Coffee on Milk Street at 3 pm on Tuesday,” is provided. At 330, a third recommendation is provided. The user can select the check box next to the recommendation that they prefer and at 340, the user can confirm the meeting location. Alternatively, at 350, the user can suggest a different location and time.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer (e.g., tablet, laptop, smart phone, etc.) having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input (e.g., touch screen).

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

What is claimed is:

1. A computer-implemented method for recommending one or more geographic locations and one or more temporal locations for a first individual and a second individual to meet, the method comprising:
receiving, at a server, first data from the first individual and second data from the second individual, the received first data specifying at least the first individual's preferred geographical attributes and preferred temporal attributes, the received second data specifying at least the second individual's preferred geographical attributes and preferred temporal attributes;
determining, using the server, the received first data, the received second data, and a recommendation engine, one or more recommended geographic locations and one or more recommended temporal locations that satisfy at least some of the respective preferred geographical attributes and the respective preferred temporal attributes; and
transmitting, using the server, the one or more recommended geographical locations and the one or more recommended temporal locations to at least one of the first individual and the second individual;
wherein the server includes one or more data processors coupled to memory.

2. The computer implemented method of claim 1, wherein geographic attributes include a boundary of a geographic region, the geographic region including a plurality of geographic locations, wherein all geographic locations within the geographic region are preferred locations to meet for an associated individual.

3. The computer implemented method of claim 2, wherein the boundary of the geographic region is specified by a current position of the associated individual and a maximum distance the associated individual is willing to travel, the current position having been automatically determined.

4. The computer implemented method of claim 1, wherein geographic attributes include a safety measure, a convenience measure, and business type.

5. The computer implemented method of claim 1, wherein temporal attributes include a predefined schedule of availability of an associated individual.

6. The computer implemented method of claim 1, wherein temporal attributes include a range of time specifying an availability of an associated individual.

7. The computer implemented method of claim 1, wherein temporal attributes include a reoccurring range of time specifying an availability of an associated individual.

8. The computer implemented method of claim 1, wherein the first individual and the second individual are meeting to finalize a previously agreed upon transaction; and
wherein the server further uses details of the transaction to determine the one or more recommended geographical locations.

9. The computer implemented method of claim 8, wherein the details of the transaction include at least one detail selected from a group consisting of: monetary value to be exchanged, type, size and number of products to be exchanged.

10. The computer implemented method of claim 1, wherein the server further uses secondary attributes associated with an individual to determine the one or more recommended geographical locations and the one or more temporal locations.

11. The computer implemented method of claim 10, wherein the secondary attributes include a relationship to another individual, and historical transaction data associated with the individual.

12. The computer implemented method of claim 1, wherein preferred attributes include a plurality of attributes, each attribute associated with a measure of importance.

13. The computer implemented method of claim 1, wherein the recommended one or more geographical locations is suboptimal and the recommended one or more temporal locations is suboptimal.

14. The computer implemented method of claim 1, wherein the recommended one or more geographical locations are presented to at least one of the first individual and the second individual for confirmation.

15. The computer implemented method of claim 1, wherein the recommended one or more temporal locations is determined independently from the recommended one or more geographical locations.

16. The computer implemented method of claim 15, wherein the first individual is prompted to choose a preferred geographic location from the one or more recommended geographic locations and a preferred temporal location from the one or more recommended temporal locations.

17. The computer implemented method of claim 1, wherein the recommendation engine is an inference engine.
